(19) United States
(12) Patent Application Publication
(10) Pub. No.: US 2015/0130391 A1
(43) Pub. Date: May 14, 2015

(54) MOTOR DRIVE CONTROLLER AND MOTOR DRIVE CONTROL METHOD, AND MOTOR SYSTEM USING THE SAME

(71) Applicant: SAMSUNG ELECTRO-MECHANICS CO., LTD., Suwon-Si (KR)

(72) Inventor: Joo Yul Ko, Suwon-Si (KR)

(73) Assignee: SAMSUNG ELECTRO-MECHANICS CO., LTD., Suwon-Si (KR)

(21) Appl. No.: 14/292,824

(22) Filed: May 31, 2014

(30) Foreign Application Priority Data
Nov. 13, 2013 (KR) 10-2013-0137388

(51) Int. Cl. H02P 6/00

(52) U.S. Cl. CPC H02P 6/002
USPC 318/722

(57) ABSTRACT

A motor drive controller may include: a current detecting unit detecting current values corresponding to a plurality of phases of a motor using a plurality of resistor elements; a correcting unit correcting an error in the detected current values caused by an error in the plurality of resistor elements; and a controlling unit controlling driving of the motor using an output of the correcting unit.

### CROSS-REFERENCE TO RELATED APPLICATION

This application claims the benefit of Korean Patent Application No. 10-2013-0137388 filed on Nov. 13, 2013, with the Korean Intellectual Property Office, the disclosure of which is incorporated herein by reference.

### BACKGROUND

The present disclosure relates to a motor drive controller and a motor drive control method, and a motor system using the same.

In accordance with the development of a motor technology, motors having various sizes have been used in a wide range of technological fields.

Generally, a motor is driven by rotating a rotor using a permanent magnet and a coil having polarities changed according to a current applied thereto. Early forms of motors included a brush-type motor having a coil on a rotor, which has a problem of the brush wearing out or sparks occurring due to the driving of the motor.

Therefore, recently, various types of brushless motor have generally been used. Such brushless motors, direct current (DC) motors driven using an electronic rectifier, instead of mechanical contact parts such as a brush, a commutator, and the like, may include coils each corresponding to respective phases, a stator generating a magnetic force by a phase voltage in each of the coils, and a rotor formed of a permanent magnet and rotating by the magnetic force of the stator.

In order for such a brushless motor to be efficiently driven, commutation of the respective coils of the stator should be performed at an appropriate point in time. In addition, in order to perform commutation appropriately, a position of the rotor should be determined.

In order to determine the position of the rotor, according to the related art, a sensing element such as a hall sensor, or the like, has commonly been used. However, in this case, there are limitations in that an overall motor system may be enlarged and a driving circuit may be required to be relatively complicated.

In order to address such limitations, a method of estimating the position of the rotor using current and voltage detected in a motor has been developed.

For example, according to the related art, current of the motor has been detected using a predetermined sensing resistor element between an inverter and a coil of the motor, voltage has been detected using a power voltage and a duty ratio, and the position of the rotor has then been determined using the detected current and voltage.

However, according to the related art, in the case in which a predetermined error is present in the sensing resistor element, the position of the rotor may be miscalculated. That is, a predetermined error resistance value is present in the resistor element due to fabrication errors, or the like, and the error of the resistance value causes an error in a current value, thereby miscalculating the position of the rotor.

### SUMMARY

An aspect of the present disclosure may provide a motor drive controller and a motor drive control method capable of more accurately calculating a position of a rotor by correcting an error in a detected current value caused by an error in a resistor element, and a motor system using the same.

According to an aspect of the present disclosure, a motor drive controller may include: a current detecting unit detecting current values corresponding to a plurality of phases of a motor using a plurality of resistor elements; a correcting unit correcting an error in the detected current values caused by an error in the plurality of resistor elements; and a controlling unit controlling driving of the motor using an output of the correcting unit.

The current detecting unit may separately detect the respective current values corresponding to the plurality of phases, using corresponding resistor elements in the plurality of phases.

The correcting unit may compare a current value detected from a first resistor element among the plurality of resistor elements with a calculated current value for the first resistor element and calculate an error for the first resistor element.

The correcting unit may perform a correction of current values of the remaining resistor elements except for the first resistor element among the plurality of resistor elements, by assuming that an error, the same as that present in the first resistor element is present in the remaining resistor elements.

The correcting unit may calculate the calculated current value for the first resistor element using current values detected from the remaining resistor elements except for the first resistor element among the plurality of resistor elements.

The correcting unit may determine half of a difference between the calculated current value and the detected current value as the error for the first resistor element.

The correcting unit may calculate respective errors for all of the plurality of phases and perform the correction using an average of the plurality of calculated errors.

According to another aspect of the present disclosure, a motor system may include: a motor performing a rotation operation according to a driving control signal; and a motor drive controller detecting current values corresponding to a plurality of phases of the motor using a plurality of resistor elements and correcting an error in the detected current values caused by an error in the plurality of resistor elements to generate the driving control signal.

The motor drive controller may include: a current detecting unit detecting current values corresponding to the plurality of phases of the motor using the plurality of resistor elements; a correcting unit correcting the error in the detected current values caused by the error in the plurality of resistor elements; and a controlling unit controlling driving of the motor using an output of the correcting unit.

The correcting unit may compare a current value detected from a first resistor element among the plurality of resistor elements with a calculated current value for the first resistor element and calculate an error for the first resistor element.

The correcting unit may perform a correction of current values of the remaining resistor elements except for the first resistor element among the plurality of resistor elements, by assuming that an error, the same as that present in the first resistor element is present in the remaining resistor elements.

The correcting unit may calculate the calculated current value for the first resistor element using current values detected from the remaining resistor elements except for the first resistor element among the plurality of resistor elements.

The correcting unit may determine half of a difference between the calculated current value and the detected current value as the error for the first resistor element.

The correcting unit may calculate respective errors for all of the plurality of phases and performs the correction using an average of the plurality of calculated errors.

According to another aspect of the present disclosure, a motor drive control method performed in a motor drive controller controlling driving of a motor, the method may include: detecting current values corresponding to a plurality of phases of the motor using a plurality of resistor elements; correcting an error in the detected current values caused by an error in the plurality of resistor elements; and controlling driving of the motor using the corrected current value.

The detecting of the current values may include separately detecting the respective current values corresponding to the plurality of phases, using corresponding resistor elements in the plurality of phases.

The correcting of the error may include comparing a current value detected from a first resistor element among the plurality of resistor elements with a calculated current value for the first resistor element and calculating an error for the first resistor element.

The correcting of the error may further include performing a correction of current values of the remaining resistor elements except for the first resistor element among the plurality of resistor elements, by assuming that an error, the same as that present in the first resistor element is present in the remaining resistor elements.

The calculating of the error may include calculating the calculated current value for the first resistor element using current values detected from the remaining resistor elements.

The calculating of the error may further include determining a value equal to half of a difference between the calculated current value and the detected current value as the error for the first resistor element.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration diagram illustrating an example of a motor system according to an exemplary embodiment of the present disclosure;

FIG. 2 is a configuration diagram illustrating an example of an inverter unit and a current detecting unit of FIG. 1;

FIG. 3 is a reference diagram illustrating a current correction operation according to an exemplary embodiment of the present disclosure;

FIG. 4 is a configuration diagram illustrating an example of a correcting unit of FIG. 1;

FIG. 5 is a configuration diagram illustrating an example of a controlling unit of FIG. 1;

FIG. 6 is a flowchart illustrating a motor drive control method according to an exemplary embodiment of the present disclosure; and

FIG. 7 is a flowchart illustrating an example of operation S620 of FIG. 6.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

In addition, hereinafter, a motor system including a motor 20 or 200 and a motor drive controller 10 or 100 for driving the motor 20 or 200 will be described.

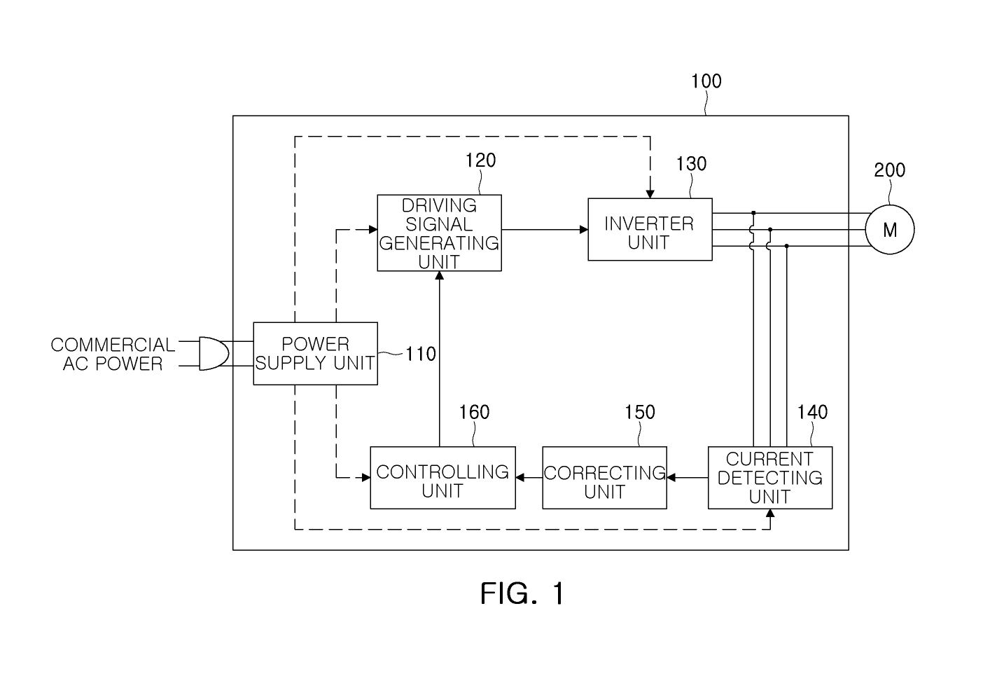

FIG. 1 is a configuration diagram illustrating an example of a motor system according to an exemplary embodiment of the present disclosure.

Referring to FIG. 1, the motor system may include the motor drive controller 100 and the motor 200.

The motor drive controller 100 may provide a driving control signal to the motor 200 to control the rotations of the motor 200.

According to the exemplary embodiment of the present disclosure, the motor drive controller 100 may detect current values corresponding to a plurality of phases of the motor 200 and generate a driving control signal by correcting an error in the detected current values caused by an error in a plurality of resistor elements.

The motor 200 may perform a rotation operation according to the driving control signal. For example, the respective coils of the motor 200 may generate magnetic fields by driving current (driving signal) provided from an inverter unit 130. The rotor included in the motor 200 may be rotated by the magnetic fields generated from the coils.

More specifically, the motor drive controller 100 may include a power supply unit 110, a driving signal generating unit 120, the inverter unit 130, a current detecting unit 140, a correcting unit 150, and a controlling unit 160.

The power supply unit 110 may supply power to the respective elements of the motor drive controller 100. For example, the power supply unit 110 may convert commercial alternating current (AC) power into direct current (DC) power to supply the converted DC voltage to the respective components. In the exemplary embodiment shown in FIG. 1, a dotted line denotes the supply of a predetermined amount of power from the power supply unit 110.

The driving signal generating unit 120 may generate a driving signal according to a control of the controlling unit 160 and provide the driving signal to the inverter unit 130.

According to the exemplary embodiment of the present disclosure, when the driving signal generating unit 120 receives the driving control signal from the controlling unit 160, it may generate the driving signal corresponding to the driving control signal. For example, the driving control signal may be a pulse width control signal and the driving signal generating unit 120 may generate a pulse width modulation signal according to the corresponding pulse width control signal.

The inverter unit 130 may perform a switching operation to provide the driving signal to the plurality of phases of the motor 200. For example, the inverter unit 130 may apply a predetermined current to the plurality of phases of the motor 200 according to the driving control signal to allow the rotor of the motor 200 to be operated.

The current detecting unit 140 may detect current values corresponding to the plurality of phases of the motor using the plurality of resistor elements.

The correcting unit 150 may correct an error in the detected current values caused by an error in the plurality of resistor elements of the current detecting unit 140.

The controlling unit 160 may control the driving of the motor 200 using an output of the correcting unit 150.

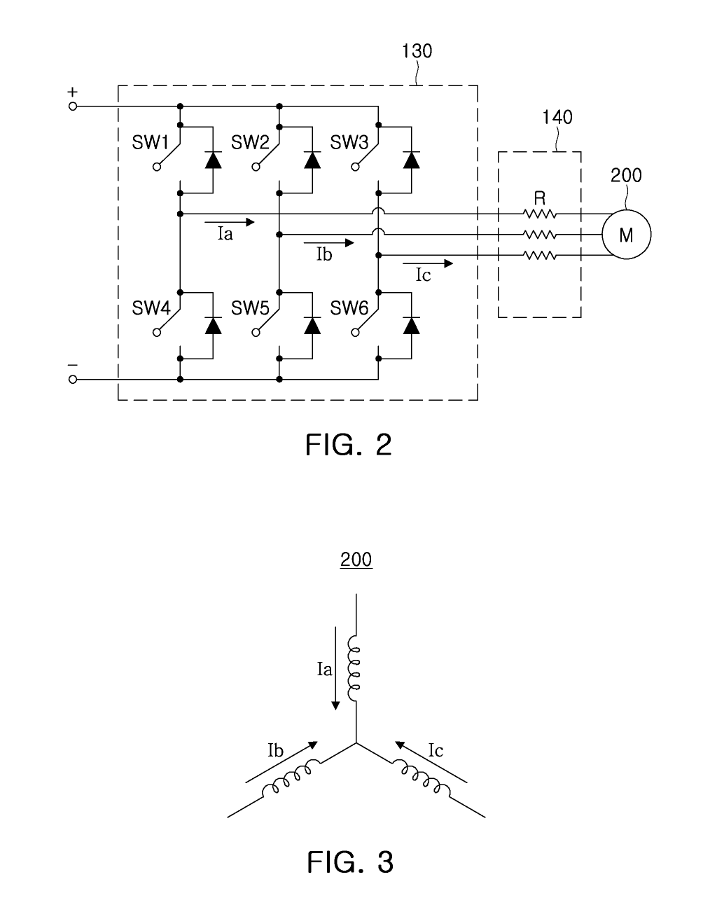

Hereinafter, the current detecting unit 140, the correcting unit 150, and the controlling unit 160 will be described in detail with reference to FIGS. 2 through 4.

FIG. 2 is a configuration diagram illustrating examples of the inverter unit and the current detecting unit of FIG. 1, and FIG. 3 is a reference diagram illustrating a current correction operation according to an exemplary embodiment of the present disclosure. The motor 200 of FIGS. 2 and 3 includes three-phase coils by way of example.

As shown in FIGS. 2 and 3, the inverter unit 130 may include a pair of switches corresponding to each phase of the motor 200. In this exemplary embodiment, the motor is a three-phase motor, and thus, six switches are provided as illustrated.

The inverter unit 130 may provide a predetermined current to the respective phases of the motor 200. In the case that the three-phases of the motor 200 are an A phase, a B phase, and a C phase, Ia, Ib, and Ic denote current values provided to the respective phases.

The current detecting unit 140 may include a plurality of resistor elements R connected to the respective phases of the motor 200. The current detecting unit 140 may separately detect the respective current values corresponding to the plurality of phases, using corresponding resistor elements in the plurality of phases.

According to an exemplary embodiment of the present disclosure, the current detecting unit 140 may detect the current using a voltage drop across a resistor element.

The plurality of resistor elements R of the current detecting unit 140 may have a predetermined error resistance value and the correcting unit 150 may correct the error resistance value.

According to an exemplary embodiment of the present disclosure, the correcting unit 150 may compare a current value detected from a first resistor element among the plurality of resistor elements with a calculated current value for the first resistor element and calculate an error in the first resistor element. Here, the correcting unit 150 may obtain the calculated current value for the first resistor element using current values detected from the remaining resistor elements except for the first resistor element among the plurality of resistor elements.

According to an exemplary embodiment of the present disclosure, the correcting unit 150 may perform the correction of current values of the remaining resistor elements except for the first resistor element among the plurality of resistor elements, by assuming that an error, the same as that present in the first resistor element, is present in the remaining resistor elements.

According to an exemplary embodiment of the present disclosure, the correcting unit 150 may determine a value equal to half of a difference between the calculated current value and the detected current value as the error.

According to an exemplary embodiment of the present disclosure, the correcting unit 150 may calculate the error for all of the plurality of phases, respectively, and perform the correction using an average of the plurality of calculated errors.

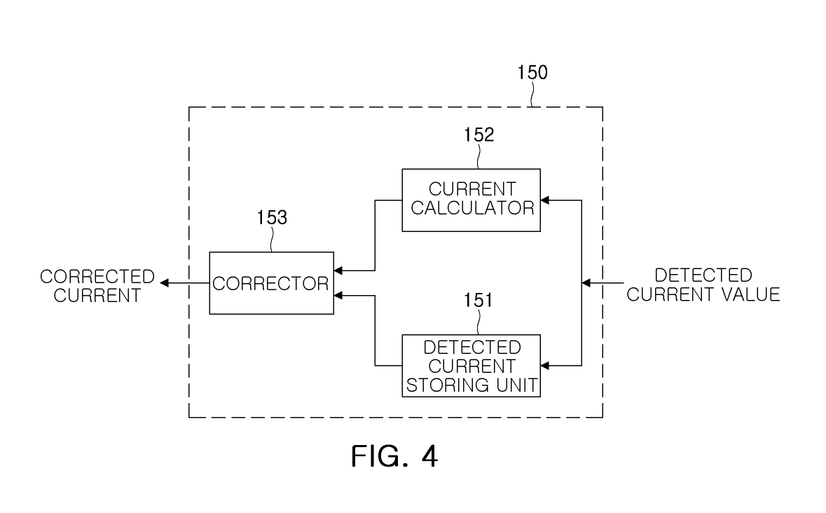

FIG. 4 is a configuration diagram illustrating an example of the correcting unit of FIG. 1. Hereinafter, various examples of the correcting unit will be described with reference to FIG. 4.

Referring to FIG. 4, the correcting unit 150 may include a detected current storing unit 151, a current calculator 152, and a corrector 153.

The detected current storing unit 151 may store the current values detected by the current detecting unit 140.

The current calculator 152 may obtain the current value detected from a specific resistor element.

The current calculator 152 may calculate the calculated current value for the specific resistor element using current values detected from the remaining resistor elements except for the specific resistor element.

For example, in a case of a motor having an A phase, a B phase, and a C phase, the current calculator 152 may calculate a calculated current value of the C phase using detected current values of the A phase and the B phase.

It may be represented by the following Equation:

Vₐ=Iₐ*(R+ΔR)

V_{b}=I_{b}*(R+ΔR)

V_{c}=I_{c}*(R+ΔR) [Equation 1]

where Va through Vc mean voltages in the respective phases and Ia through Ic mean the detected current values in the respective phases. R is a resistance value of the resistor element and ΔR is an error resistance value.

In the above-mentioned Equations, it is assumed that the same error value is present in different resistor elements. That is, the correcting unit 150 may perform the correction of current values of the remaining resistor elements except for the first resistor element of the plurality of resistor elements, by assuming that an error, the same as that present in the first resistor element, is present in the remaining resistor elements.

The reason is that when the error is present, a difference between the error value and a required value is very larger than a difference between the error values. According to the above-mentioned assumption, the error may be simply corrected as in the following Equation.

As described above with reference to FIG. 2, since the respective currents are directed to one connection point, the Kirchhoff's current law may be applied. Therefore, Equation 2 may be satisfied.

Ia+Ib+Ic=0 [Equation 2]

where the respective detected current values include error components due to the error resistance value, which may be represented by the following Equation.

Ia=Ia_real+ΔIa,

Ib=Ib_real+ΔIb

Ic=Ic_real+ΔIb [Equation 3]

Meanwhile, Ic may be calculated from Ia and Ib. That is, the calculated current value for the C phase may be calculated as follows by the Kirchhoff's current law and the detected current values for Ia and Ib.

Ic=−(Ia_{—}real+Ib_{—}real)−(ΔIa+ΔIb) [Equation 4]

The corrector 153 may compare the detected current values stored in the detected current storing unit 151 with the calculated current value calculated by the current calculator 152 as described above, and calculate the error for the resistor element.

Considering Equation 3 and Equation 4, a difference between the calculated current value for the C phase and an actual current value may be represented by the following Equation.

ΔIc=−(ΔIa+ΔIb) [Equation 5]

where in the case that ΔIa and ΔIb in Equation 5 are equal to each other, they may be represented by the following Equation.

ΔIc=−(ΔIa/2)*2 [Equation 6]

As a result, the corrector 153 may determine the half of the difference between the detected current value and the calculated current value as a current error value.

According to an exemplary embodiment of the present disclosure, the corrector 153 may calculate the errors for all of the plurality of phases, respectively, and perform the correction using an average of the plurality of calculated errors. In this case, Equation 1 to Equation 6 are used to calculate the error for Ic, and the corrector 153 may calculate the errors for Ia and Ib using the above-described Equations, respectively, and may perform the correction using the average of Ia, Ib, and Ic.

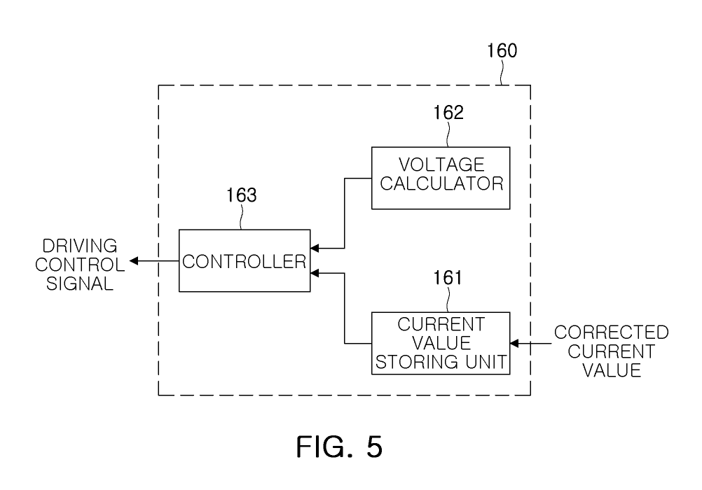

FIG. 5 is a configuration diagram illustrating an example of the controlling unit of FIG. 1.

Referring to FIG. 5, the controlling unit 160 may include a current value storing unit 161, a voltage calculator 162, and a controller 163.

The current value storing unit 161 may store corrected current value provided from the correcting unit 150.

The voltage calculator 162 may calculate a voltage value of the driving signal. For example, the voltage calculator 162 may calculate a voltage value by multiplying a pulse width modulation duty with a power voltage.

The controller 163 may calculate a position of the rotor using at least one of the calculated voltage value and the corrected current value. Since the controller 163 may be configured in various schemes, the present disclosure does not limit a scheme in which the controller 163 determines the position of the rotor to a particular scheme.

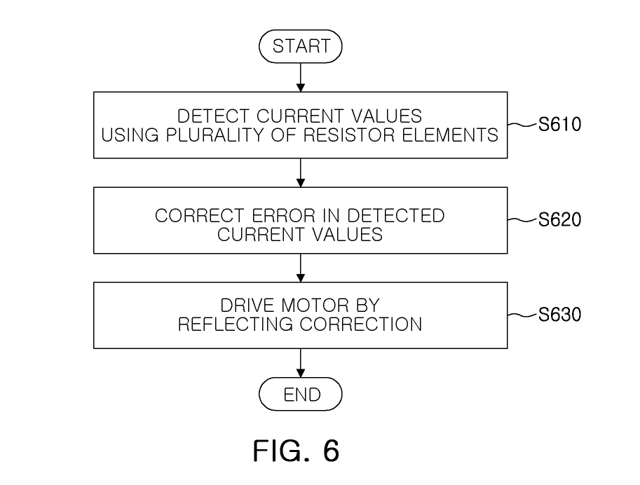

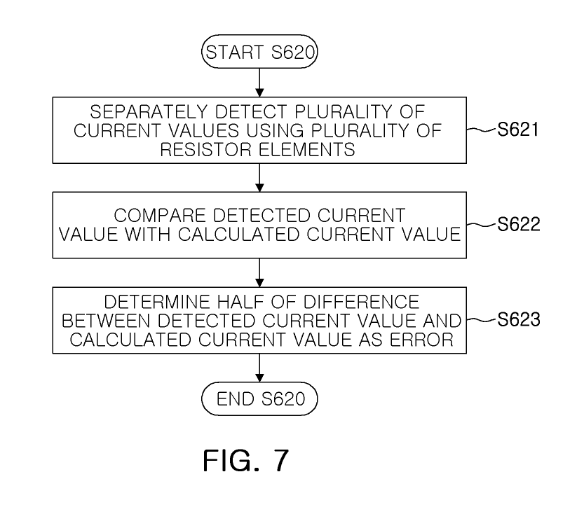

FIG. 6 is a flowchart illustrating a motor drive control method according to an exemplary embodiment of the present disclosure and FIG. 7 is a flowchart illustrating an example of operation S620 of FIG. 6.

Hereinafter, a motor drive control method according to an exemplary embodiment of the present disclosure will be described with reference to FIGS. 6 and 7.

Since motor drive control methods according to exemplary embodiments of the present disclosure are performed in the motor drive controller 100 described above with reference to FIGS. 3 through 6, redundant descriptions of the same or similar elements will be omitted.

Referring to FIGS. 6 and 7, the motor drive controller 100 may detect current values corresponding to a plurality of phases of a motor using a plurality of resistor elements (S610).

Next, the motor drive controller 100 may correct an error in the detected current values caused by an error in the plurality of resistor elements (S620).

The motor drive controller 100 may control driving of the motor using the corrected current (S630).

In an example of S620, the motor drive controller 100 may separately detect the respective current values corresponding to the plurality of phases, using corresponding resistor elements in the plurality of phases.

In an example of S620, the motor drive controller 100 may compare a current value detected from a first resistor element among the plurality of resistor elements with a calculated current value for the first resistor element (S622) and calculate an error for the first resistor element. Here, the motor drive controller 100 may obtain the calculated current value for the first resistor element using current values detected from the remaining resistor elements except for the first resistor element among the plurality of resistor elements.

In an example of S620, the motor drive controller 100 may perform a correction of current values of the remaining resistor elements except for the first resistor element among the plurality of resistor elements, by assuming that an error, the same as that present in the first resistor element, is present in the remaining resistor elements.

In an example of S620, the motor drive controller 100 may determine a value equal to half of a difference between the calculated current value and the detected current value as an error (S623).

As set forth above, according to exemplary embodiments of the present disclosure, the position of the rotor may be more accurately determined by correcting an error in the detected current caused by an error in a resistor element.

While exemplary embodiments have been shown and described above, it will be apparent to those skilled in the art that modifications and variations could be made without departing from the spirit and scope of the present disclosure as defined by the appended claims.

What is claimed is:

1. A motor drive controller, comprising:
a current detecting unit detecting current values corresponding to a plurality of phases of a motor using a plurality of resistor elements;
a correcting unit correcting an error in the detected current values caused by an error in the plurality of resistor elements; and
a controlling unit controlling driving of the motor using an output of the correcting unit.

2. The motor drive controller of claim 1, wherein the current detecting unit separately detects the respective current values corresponding to the plurality of phases, using corresponding resistor elements in the plurality of phases.

3. The motor drive controller of claim 1, wherein the correcting unit compares a current value detected from a first resistor element among the plurality of resistor elements with a calculated current value for the first resistor element and calculates an error for the first resistor element.

4. The motor drive controller of claim 3, wherein the correcting unit performs a correction of current values of the remaining resistor elements except for the first resistor element among the plurality of resistor elements, by assuming that an error, the same as that present in the first resistor element is present in the remaining resistor elements.

5. The motor drive controller of claim 3, wherein the correcting unit calculates the calculated current value for the first resistor element using current values detected from the remaining resistor elements except for the first resistor element among the plurality of resistor elements.

6. The motor drive controller of claim 3, wherein the correcting unit determines half of a difference between the calculated current value and the detected current value as the error for the first resistor element.

7. The motor drive controller of claim 3, wherein the correcting unit calculates respective errors for all of the plurality of phases and performs the correction using an average of the plurality of calculated errors.

8. A motor system, comprising:
a motor performing a rotation operation according to a driving control signal; and
a motor drive controller detecting current values corresponding to a plurality of phases of the motor using a plurality of resistor elements and correcting an error in the detected current values caused by an error in the plurality of resistor elements to generate the driving control signal.

9. The motor system of claim 8, wherein the motor drive controller includes:
a current detecting unit detecting current values corresponding to the plurality of phases of the motor using the plurality of resistor elements;
a correcting unit correcting the error in the detected current values caused by the error in the plurality of resistor elements; and
a controlling unit controlling driving of the motor using an output of the correcting unit.

10. The motor system of claim 9, wherein the correcting unit compares a current value detected from a first resistor element among the plurality of resistor elements with a calculated current value for the first resistor element and calculates an error for the first resistor element.

11. The motor system of claim 10, wherein the correcting unit performs a correction of current values of the remaining resistor elements except for the first resistor element among the plurality of resistor elements, by assuming that an error, the same as that present in the first resistor element is present in the remaining resistor elements.

12. The motor system of claim 10, wherein the correcting unit calculates the calculated current value for the first resistor element using current values detected from the remaining resistor elements except for the first resistor element among the plurality of resistor elements.

13. The motor system of claim 10, wherein the correcting unit determines half of a difference between the calculated current value and the detected current value as the error for the first resistor element.

14. The motor system of claim 10, wherein the correcting unit calculates respective errors for all of the plurality of phases and performs the correction using an average of the plurality of calculated errors.

15. A motor drive control method performed in a motor drive controller controlling driving of a motor, the method comprising:
detecting current values corresponding to a plurality of phases of the motor using a plurality of resistor elements;
correcting an error in the detected current values caused by an error in the plurality of resistor elements; and
controlling driving of the motor using the corrected current value.

16. The motor drive control method of claim 15, wherein the detecting of the current values includes separately detecting the respective current values corresponding to the plurality of phases, using corresponding resistor elements in the plurality of phases.

17. The motor drive control method of claim 15, wherein the correcting of the error includes:
comparing a current value detected from a first resistor element among the plurality of resistor elements with a calculated current value for the first resistor element; and
calculating an error for the first resistor element.

18. The motor drive control method of claim 17, wherein the correcting of the error further includes performing a correction of current values of the remaining resistor elements except for the first resistor element among the plurality of resistor elements, by assuming that an error, the same as that present in the first resistor element is present in the remaining resistor elements.

19. The motor drive control method of claim 17, wherein the calculating of the error includes calculating the calculated current value for the first resistor element using current values detected from the remaining resistor elements.

20. The motor drive control method of claim 17, wherein the calculating of the error further includes determining a value equal to half of a difference between the calculated current value and the detected current value as the error for the first resistor element.
